(19) United States
(12) Patent Application Publication
(10) Pub. No.: US 2015/0170181 A1
(43) Pub. Date: Jun. 18, 2015

(54) SYSTEM AND METHOD FOR ENFORCING REDEMPTION LIMITS ON MOBILE COUPONS

(71) Applicant: UPSIDE COMMERCE, INC., Bellevue, WA (US)

(72) Inventors: Jeffrey SAMPSON, Sammamish, WA (US); Adrian BOSTON, Vancouver (CA)

(21) Appl. No.: 14/569,557

(22) Filed: Dec. 12, 2014

Related U.S. Application Data
(60) Provisional application No. 61/915,448, filed on Dec. 12, 2013.

(51) Int. Cl. G06Q 30/02

(52) U.S. Cl. CPC G06Q 30/0225; G06Q 30/0267

(57) ABSTRACT

The invention describes a two-dimensional system for limiting digital discount offers by time and volume. Digital coupons are entered into a database by way of a web portal, at which time the deal's expiration date and the maximum number of redemptions to be allowed is set. Digital Offers are delivered to consumers' Mobile Devices via a mobile application, which alerts the consumer to the length of the offer period (the expiration date) and the number of available redemptions remaining. Consumers who signal intent to redeem an offer have a specified time period to perform the redemption in-store, otherwise the Digital Offer returns to the available pool. Consumers may exchange rewards “points” in the application for an extension of the time in which they are allowed to redeem the Digital Offer.

### FIELD

The present disclosure relates to redemption techniques for digital coupons. More particularly, to apparatus, systems and methods for limiting digital discount offers by time and volume.

### BACKGROUND

Paper coupons have decades of history that gives consumer packaged goods brands (CPGs) confidence in their use and ability to forecast redemption rates and associated promotion costs based on historical performance. Typically a CPG will publish a promotional offer consisting of a discount on a specified product (or products) valid for certain time period at participating retailers via free-standing inserts (FSI) in newspapers to a regional audience of 40-50 million households, and historical patterns indicate that the average redemption rate will be approximately 0.49%. Brand managers use these historical numbers to generate reasonably estimated projections for the bottom-line expense of a promotional campaign and reserve the appropriate internal budget to pay. Promotion costs which exceed the CPG's approved internal budget have the ability to negatively affect the profit and loss performance of not only the promoted brand but the entire CPG company.

As the market shifts from paper distribution to digital, CPG confidence in the ability to forecast redemption volume drastically deteriorates given the significantly larger reach of social media and the lack of established redemption rates in new distribution channels. Social sharing makes it nearly impossible to limit the number of people who receive the offer, particularly for CPG companies that have online followings of greater than one million “fans.” Moreover, there is no history of use to define the typical redemption rate of a digital coupon. A redemption rate that runs too low will burden the brand with excess inventory, while a rate that runs too high can cause a promotion to run significantly over budget.

### BRIEF SUMMARY OF THE INVENTION

The invention describes a two-dimensional system for limiting digital discount offers by time and volume on mobile devices (defined as mobile phone or tablet computer form factors which transmit and receive data over wireless local area, cellular or other data networks, the “Mobile Devices”). The definitional components and details of a digital coupon are entered into a database (any form of data storage whereby data is housed on remote, local, cloud-based, storage area network, network attached storage or computer in relational or non-relational schema) by way of a secure, Internet web portal, at which time the coupon's expiration date and the maximum number of redemptions to be allowed are set by the CPG (the “Digital Offer”). The Digital Offer is then published from the database to social media networking sites or pages affiliated with the CPG. Consumers who “follow”, “friend”, “like” or similar opt-in actions on the related CPG social page are shown the Digital Offer. Consumers who accept the Digital Offer download a federated mobile application which delivers the digital coupon to consumers' Mobile Devices which alerts the consumer to the length of the offer period (the expiration date) and the number of available redemptions remaining. Consumers signal intent to redeem an offer through a reservation system providing a specified time period in which it is guaranteed that they will be able to redeem the Digital Offer in-store; if not redeemed within the specified reservation period the deal returns to the available pool of digital coupons for other consumers to redeem. Consumers may exchange reward “points” in the mobile application for an extension of the guaranteed period in which they can redeem the Digital Offer.

### BRIEF DESCRIPTION OF THE DRAWINGS

The aspects of the present disclosure are best understood from the detailed description when read in relation to the accompanying drawings. The drawings illustrate a variety of different aspects, features, and embodiments of the disclosure, as such it is understood that the illustrated embodiments are merely representative and not exhaustive in scope.

FIG. 1 illustrates a suitable operating environment showing an offer system that sends and validates a stream of 2-dimensional digital offers to the Mobile Users and adjoining redemption system that receives and validates a stream of redemptions of said digital offers from the Mobile Users in accordance with at least one embodiment.

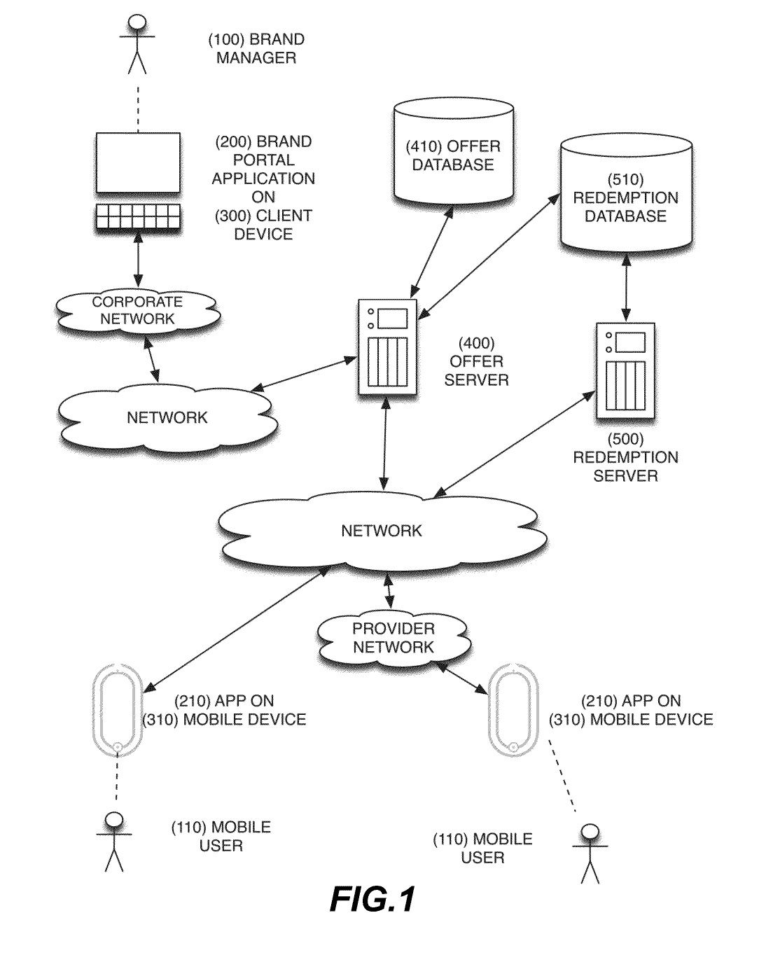

FIG. 2 illustrates a flow diagram of a process by which Digital Offers are created, published to consumer Mobile Devices, and updated in near real time in accordance with one embodiment.

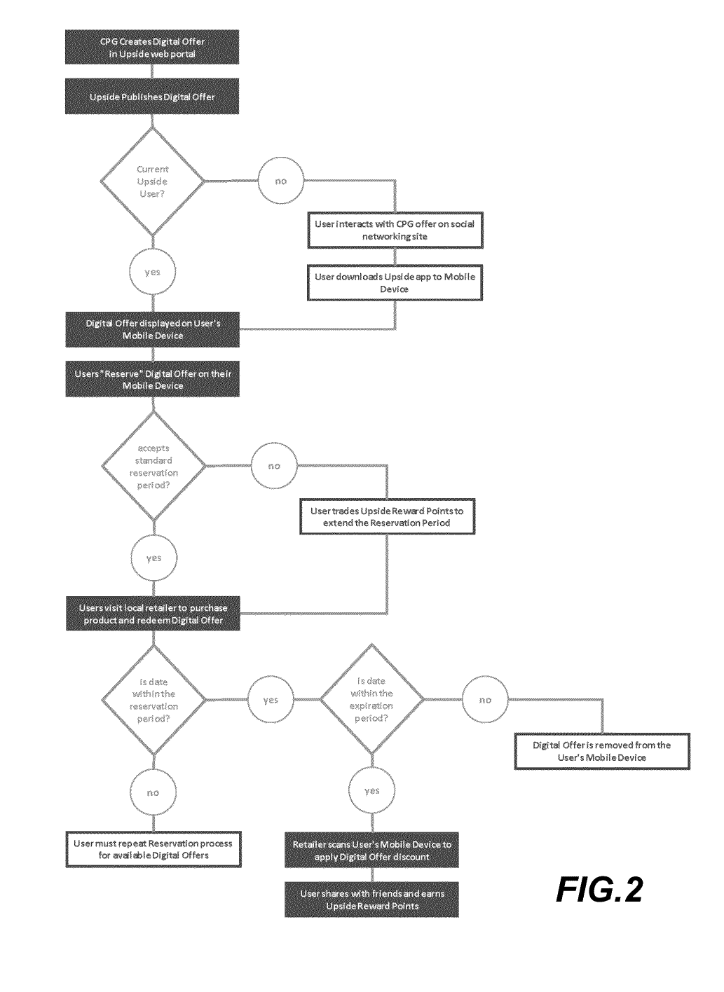

FIG. 3 illustrates a flow diagram of a process by which Digital Offers and corresponding reserves are created, published, managed, and redeemed in accordance with one embodiment.

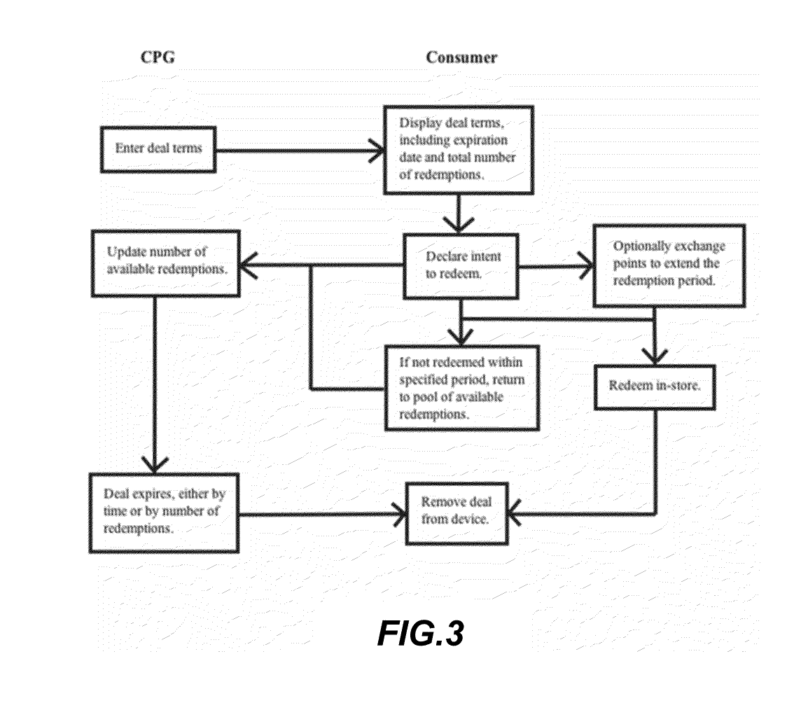

### DETAILED DESCRIPTION

In accordance with various embodiments of the invention, apparatus, systems and methods to enforce redemption limits on mobile coupons are described that overcome the hereinafore-mentioned disadvantages of the heretofore-known digital mobile coupon redemption methods and systems of this general type.

The shift from paper distribution to digital exposes CPGs to risk when issuing promotional offers. Regional distribution of a paper coupon within a FSI may reach as many as 50 million households, but the well-established redemption rate for paper coupons (0.49%) allowed brand managers to forecast the cost of upcoming promotions and budget for those costs.

The classic delivery method of the FSI—the daily newspaper—is now in sharp decline. Digital sources of information and insight require new digital delivery channels and methods. CPGs must find a way to shift their promotional campaigns from paper to digital media, but doing so exposes them to new risks. When coupons go out over digital networks, there is no historical record by which to predict redemption rates, nor is there a way to limit the size of the audience that receives an offer, either by direct broadcast or peer-to-peer sharing. Large consumer brands have online “fans” or followers that number in the high tens of millions, and social networks such as Facebook and Twitter make it easy for these fans to share offers within their networks of friends and family.

Likewise, the psychographic information that can be collected via digital networks allows for discount offers to be targeted with far greater precision than a paper coupon received. The FSI distribution of paper coupons assumed that fewer than 1 reader in 100 would be interested in the offer and be able to find it during the promotional period, but the redemption rate for a targeted, personalized digital offer based on a consumer's interests and consumption patterns is likely to vary significantly from historical analogues. CPGs that publish discount offers over digital platforms consequently run two significant risks. The first is that the promotional campaign will generate a total number of redemptions far greater than anticipated, with the result that available inventory may be depleted and the cost of the promotional campaign could far exceed the internal budget allocated to mobile coupon redemption. The second risk is that the number of redemptions may be significantly less than expected, resulting in excess inventory that in some cases may be remedied by disposing of product or dumping it on market below cost.

Prior art has established chronological limits to promotional offers (e.g. “Offer good through July 31”). These systems offer no protection to the CPG brand in the event that redemptions run significantly higher than anticipated. Accurate promotional budget forecasting requires digital deal controls that offer a higher degree of precision.

The present invention is a method of issuing Digital Offers for a CPG's products via a mobile application on consumer Mobile Devices (e.g. iPhone, Android, Windows Phone, iPad, Surface, and other tablet computers) that communicates with a back-end database to communicate and enforce chronological and numerical limits on deal redemptions. Consumers install the application on their Mobile Device and designate the CPGs from which they would like to receive offers. Brand managers (100) log into a “brand portal” application (200) via his desktop or mobile client device (300) to enter deal description and terms; the brand application (200) connects to the offer server (400) which saves the descriptions and terms in an offer database (410); these terms include (but are not limited to) a deal expiration date and a maximum number of redemptions. The offer server (400) publishes the offers from one or more manufacturers to the consumer (110) by way of a Mobile app (210) residing on the consumers' Mobile Device (310). When a new deal is published to a consumers' (110) Mobile Device (210), the display screen indicates the terms of the offer, images associated with the offer, the expiration date and may reveal the total number of redemptions remaining The consumer (110) then redeems one or more offers at the retailer by revealing their terms, expiration dates and necessary data graphics to the automatic or human cashier. In one embodiment, the Mobile app (210) may connect via a provider network, such as the retailer's Wifi or a provider's cellular network, to the redemption server (500). Alternatively, the Mobile app (210) may connect using a communication network, such as the Internet, to the redemption server (500). The redemption server (500) adjusts the redemption counters of the effected offers and persists the data to the redemption database (510). Data collected by the redemption server (500) and stored in the redemption database (510) includes but is not limited to time and date of redemption, the user identifier and information, demographic information of the user, the name of the retailer, geographic location of the redemption, information concerning the version of the Mobile application (210) as well as the underlying mobile device (310) used during redemption.

In addition to an immediate redemption, A consumer (110) may also use the Mobile application (210) to signal future intent to redeem the offer via the redemption server (500); this in-store redemption must occur within a specified period (such as 48 hours), or the Digital Offer will return to the available pool for other consumers to redeem. Consumers who have used the application to redeem other offers, and who have accrued reward “points” thereby, will have the opportunity to exchange some of these points to remove the time limit; they will then have until the deal's expiration date to redeem the offer in-store. When a deal is redeemed, the mobile application (210) communicates the redemption back to the user profile stored in the database (510), so that redemption totals may be tracked and published in near real time.

At any point while a Digital Offer is live (during the stated promotional period), a brand manager (100) may enter the brand portal (200) to edit the deal settings and extend the expiration date or increase the number of available redemptions. Otherwise a promotion expires when one of two conditions is met: either the expiration date arrives, or the total number of available redemptions reaches zero. When a promotion reaches one of these two limits it is no longer active and the Digital Offer is automatically removed from the mobile application (210) on consumers' Mobile Devices (310).

It will be recognized that the present invention includes a number of advantages in that the method allows a brand manager (110) to closely monitor the course of a campaign, extending the expiration date or revising the number of available redemptions to “tune” a Digital Offer and bring it in at an optimal number of total redemptions. Alternatively, the brand manager (110) could set a very short expiration date (such as 24 hours) to test and measure the effect of urgency on consumers' purchasing decisions. The near real-time aspect of the deal reporting system allows promotional campaigns to be fully interactive for CPG brand managers, giving them far greater control over the outcome of a campaign than they enjoyed with the prior art.

Although specific embodiments have been illustrated and described herein, a whole variety of alternate and/or equivalent implementations may be substituted for the specific embodiments shown and described without departing from the scope of the present disclosure. This application is intended to cover any adaptations or variations of the embodiments discussed herein.

1. A two-dimensional system for reducing risk associated with digital promotion campaigns by limiting deals via chronology and volume, the system including the steps of: creating a digital deal using a web interface to a database; establishing a communications link between the server and a mobile application installed on consumer Mobile Devices; publishing new, personalized deals to the mobile application; displaying digital deal limits within the mobile application remotely removing expired deals from consumers' Mobile Devices; communicating redemption information to the server; and reporting, via a web interface, offer terms, distribution, number of consumers signaling intent to redeem, number of deals shared within social networks, and total number of redemptions to date.

2. A system according to claim 1 whereby users reserve the right to redeem an offer; the system including the steps of registering consumer intent to redeem an offer and communicating this intent back to the server; limiting the available time for redemption to a specific time period and displaying remaining time within the mobile application; communicating failure to redeem within the time provided to the server; registering consumer exchange of mobile application reward points for an extension of the redemption period;

3. A system according to claim 1 wherein the digital deal data items include:
expiration date, which is representative of the date by which the deal must be redeemed in-store; and volume of redemptions, which is representative of the total number of redemptions that will be made available to consumers.
